(19) United States
(12) Patent Application Publication
(10) Pub. No.: US 2025/0308785 A1
(43) Pub. Date: Oct. 2, 2025

(54) MULTILAYER CERAMIC ELECTRONIC COMPONENT AND METHOD FOR MANUFACTURING MULTILAYER CERAMIC ELECTRONIC COMPONENT

(71) Applicant: TAIYO YUDEN CO., LTD., Tokyo (JP)

(72) Inventor: Shohei KITAMURA, Takasaki-shi (JP)

(21) Appl. No.: 19/089,497

(22) Filed: Mar. 25, 2025

(30) Foreign Application Priority Data
Mar. 29, 2024 (JP) 2024-056478

(51) Int. Cl. H01G 4/12; H01G 4/008; H01G 4/33

(52) U.S. Cl. CPC H01G 4/1227; H01G 4/008; H01G 4/33

(57) ABSTRACT

A multilayer ceramic electronic component includes: multiple dielectric layers laminated along a first axis; multiple internal electrode layers respectively placed along the first axis between the adjacent pairs of the dielectric layers; and intermediate regions placed between the dielectric layers and the internal electrode layers, respectively; wherein the dielectric layers contain a compound expressed by the general formula ABO_{3-α} (0≤α≤1) and having a perovskite structure, as well as an additive element; the internal electrode layers contain a base metal element as the main component, as well as copper; the intermediate regions contain the additive element as well as copper; and the additive element encompasses one or more types selected from holmium, yttrium, samarium, dysprosium, europium, gadolinium, terbium, erbium, thulium, and ytterbium.

### CROSS-REFERENCE TO RELATED APPLICATIONS

The present application claims priority to Japanese Patent Application No. 2024-056478, filed Mar. 29, 2024, the disclosure of which is incorporated herein by reference in its entirety including any and all particular combinations of the features disclosed therein.

### BACKGROUND

### Field of the Invention

The present disclosure relates to a multilayer ceramic electronic component and a method for manufacturing multilayer ceramic electronic component.

### Description of the Related Art

A multilayer ceramic electronic component has a structure of dielectric layers and internal electrode layers laminated together alternately. Multilayer ceramic electronic components include multilayer ceramic capacitors (MLCC), and the like.

Multilayer ceramic capacitors and other multilayer ceramic electronic components are facing calls for further performance enhancements and reliability improvements in the forms of size reduction, capacity increase, and the like, as the mobile phones and other electronic devices in which they are mounted become increasingly multi-functional/higher in performance, etc. To answer these calls, attempts have been made, for example, to add various types of elements and compounds to the dielectric layers, etc.

For example, Patent Literature 1 discloses a dielectric porcelain composition that contains a barium calcium titanate expressed by the compositional formula Ba₍₁₋ₓ₎CaₓTiO₃ (x is 0.05 or greater but no greater than 0.1) as the main component, while also containing an oxide of Y and an oxide of Yb as secondary components.

According to the dielectric porcelain composition disclosed in Patent Literature 1, high insulation resistance, as well as temperature characteristics of capacitance (capacitance temperature characteristics) conforming to the X9R properties under the EIA standard, i.e., characteristics that the rate of change in capacity over a range of −55 to 175° C. falls within ±15%, are reportedly satisfied.

### BACKGROUND ART LITERATURES

Patent Literature 1: Japanese Patent Laid-open No. 2017-114751

### SUMMARY

While multilayer ceramic electronic components are being required to use thinner dielectric layers in order to support size reduction, capacity increase, and the like, making the dielectric layers thinner increases the electric field strength to be impressed on the dielectric layers. As a result, making the dielectric layers thinner renders the dielectric layers more susceptible to damage when voltage is impressed on the dielectric layers, which tends to shorten the service life of the multilayer ceramic electronic component.

To ensure that multilayer ceramic electronic components have adequate service life, adding additive elements, etc., to the dielectric layer material has been studied. However, adding additive elements to the dielectric layer material, and also increasing their additive amounts, presents a problem of lower bias properties.

An object of the present disclosure is to provide a multilayer ceramic electronic component offering high service life characteristics as well as sufficient bias properties.

The multilayer ceramic electronic component proposed by the present disclosure comprises: multiple dielectric layers laminated along a first axis; multiple internal electrode layers respectively placed along the first axis between the adjacent pairs of the dielectric layers; and intermediate regions placed between the dielectric layers and the internal electrode layers, respectively; wherein: the dielectric layers contain a compound expressed by the general formula ABO_{3-α} (0≤α≤1) and having a perovskite structure, as well as an additive element, wherein A and B represent an A-site element and a B-site element, respectively, of the perovskite structure; the internal electrode layers contain a base metal element as the main component, as well as copper; the intermediate regions have a higher content of the additive element than in the internal electrode layers, respectively, and a higher content of copper than in the dielectric layers, respectively, based on, for example, STEM-EDX analysis; and the additive element encompasses one or more types selected from holmium, yttrium, samarium, dysprosium, europium, gadolinium, terbium, erbium, thulium, and ytterbium.

According to the present disclosure, a multilayer ceramic electronic component offering high service life characteristics as well as sufficient bias properties can be provided.

### BRIEF DESCRIPTION OF THE DRAWINGS

FIG. 1 is a perspective partial cross-sectional view illustrating the multilayer ceramic capacitor pertaining to an embodiment of the present disclosure.

FIG. 2 is a cross-sectional view illustrating the multilayer ceramic capacitor pertaining to an embodiment of the present disclosure.

FIG. 3 is a cross-sectional view illustrating the multilayer ceramic capacitor pertaining to an embodiment of the present disclosure.

FIG. 4 is a cross-sectional view illustrating the details of the element body pertaining to an embodiment of the present disclosure.

FIGS. 5A to 5D are drawings explaining a method for specifying presence or absence of intermediate regions.

FIG. 6 is a flow chart of a method for manufacturing the multilayer ceramic capacitor pertaining to an embodiment of the present disclosure.

FIGS. 7A and 7B provide drawings illustrating a method for manufacturing the multilayer ceramic capacitor pertaining to an embodiment of the present disclosure.

FIG. 8 shows an example of measured results of three-dimensional atom probe analysis.

### DETAILED DESCRIPTION OF EMBODIMENTS

An embodiment of the present disclosure is explained in detail below; however, the present disclosure is not limited to these details. It should be noted that, in this Specification and the drawings attached hereto, those components that effectively have the same functional configuration are sometimes denoted by the same symbols to omit redundant explanations. Also, the drawings show, as deemed appropriate, the X-axis, Y-axis, and Z-axis that are mutually orthogonal to each other. The X-axis, Y-axis, and Z-axis specify a fixed coordinate system that is fixed for the multilayer ceramic capacitor representing an example of multilayer ceramic electronic component. When the outer shape of the multilayer ceramic capacitor representing an example of multilayer ceramic electronic component is a roughly rectangular parallelepiped, the X-axis, Y-axis, and Z-axis can correspond to the length, width, and height of the multilayer ceramic capacitor. The multilayer ceramic electronic component in this embodiment is explained below using the multilayer ceramic capacitor representing an example of multilayer ceramic electronic component.

### Multilayer Ceramic Electronic Component

### (1) Structure of Multilayer Ceramic Electronic Component

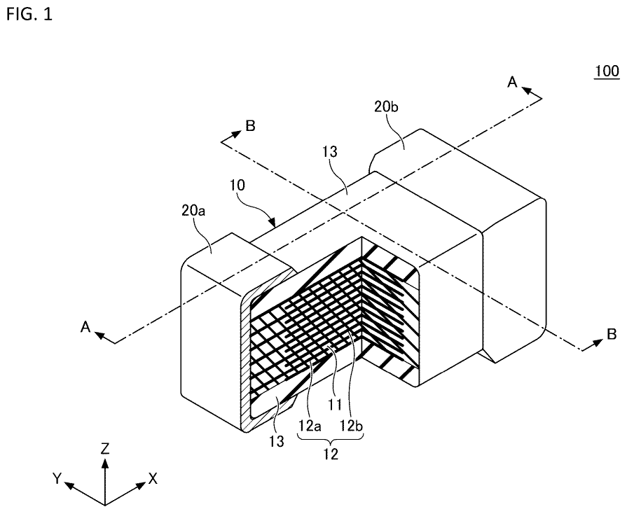

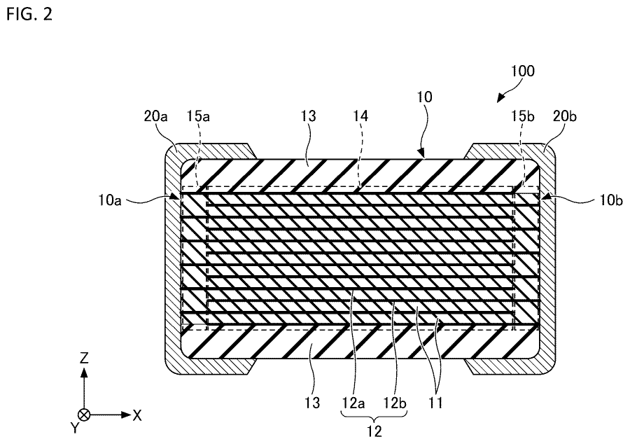

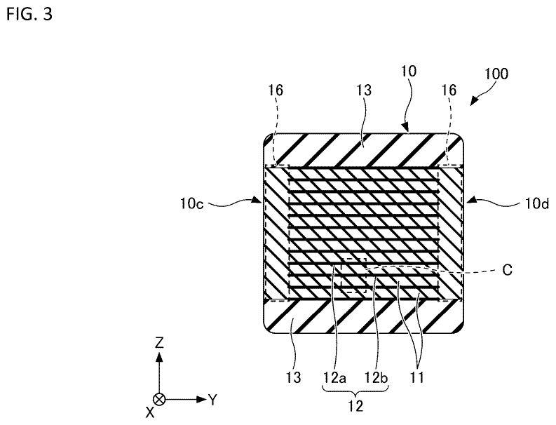

FIG. 1 is a perspective partial cross-sectional view illustrating a multilayer ceramic capacitor 100. FIGS. 2 and 3 are cross-sectional views illustrating the multilayer ceramic capacitor. FIG. 2 is a cross-sectional view along line A-A in FIG. 1. FIG. 3 is a cross-sectional view along line B-B in FIG. 1. As illustrated in FIGS. 1 to 3, the multilayer ceramic capacitor 100 has an element body 10 having a roughly rectangular parallelepiped shape. In the element body 10, the two opposing faces on its surface are referred to as the “top face” and “bottom face,” while the four faces that connect the top face and bottom face are referred to as the “side faces.” Normally the bottom face represents, but is not limited to, the face on the board side when the multilayer ceramic capacitor is mounted on a circuit board. In the examples shown in FIGS. 1 to 3, the element body 10 is such that a first external electrode 20a and a second external electrode 20b are provided on a first side face 10a and a second side face 10b (refer to FIG. 2), respectively, which correspond to the two opposing side faces. The first external electrode 20a extends from the first side face 10a onto the four adjoining faces. The second external electrode 20b extends from the second side face 10b onto the four adjoining faces. It should be noted, however, that the first external electrode 20a and second external electrode 20b are separated from each other. The external electrodes are not limited to being on the two opposing side faces, so long as they are provided on the surface of the element body 10.

The lamination direction in which dielectric layers 11 and internal electrode layers 12 are laminated is the first axis, and in FIGS. 1 to 3, the first axis representing the lamination direction of the dielectric layers 11 and internal electrode layers 12 corresponds to the Z-axis, being the direction in which the internal electrode layers are facing each other.

The axis orthogonal to the first axis representing the lamination direction is the second axis. In FIGS. 1 to 3, the second axis, which is the axis orthogonal to the first axis, corresponds to the X-axis. The second axis runs along the length direction of the element body 10 and is the axis running along the direction in which the first side face 10a and second side face 10b of the element body 10 are facing each other, as well as the direction in which the first external electrode 20a and second external electrode 20b are facing each other.

The axis orthogonal to the first axis representing the lamination direction and also orthogonal to the second axis, is the third axis. The third axis is the axis that runs along the width of the internal electrode layers 12. In FIGS. 1 to 3, the third axis, which is orthogonal to the first axis representing the lamination direction and also orthogonal to the second axis, corresponds to the Y-axis and is the axis running along the direction in which a third side face 10c and a fourth side face 10d being the two side faces, besides the first side face 10a and second side face 10b, of the four side faces of the element body 10, are facing each other (refer to FIG. 3). The X-axis, Y-axis, and Z-axis are mutually orthogonal.

The lamination direction is not limited to the Z-direction and may be any arbitrary direction. Accordingly, the first axis representing the lamination direction may be, for example, the X-axis corresponding to the X-direction or Y-axis corresponding to the Y-direction.

In this Specification, a drawing illustrating a specific embodiment may be used to explain general embodiments encompassing the specific embodiment; however, any subject matter explained based on the coordinate axis system used in an embodiment is applied correspondingly in general embodiments as being based on a general coordinate system in which the lamination direction is the first axis. For example, what are used in FIGS. 1 to 3 representing a specific embodiment where the lamination direction corresponds to the Z-direction, and are explained as the X-axis, Y-axis, and Z-axis therein, can be applied correspondingly as the second axis, third axis, and first axis, respectively, in general embodiments.

The element body 10 is constituted in such a way that dielectric layers 11 containing a ceramic material that functions as a dielectric, and internal electrode layers 12, are laminated together alternately. The internal electrode layers 12 include multiple first internal electrode layers 12a and multiple second internal electrode layers 12b. The first internal electrode layers 12a and second internal electrode layers 12b are laminated together alternately. The edges of the first internal electrode layers 12a are extracted to the surface on which the first external electrode 20a is provided, or specifically first side face 10a in the examples of FIGS. 1 to 3, of the element body 10. The edges of the second internal electrode layers 12b are extracted to the surface on which the second external electrode 20b is provided, or specifically second side face 10b in the examples of FIGS. 1 to 3, of the element body 10. This means that the first internal electrode layers 12a and second internal electrode layers 12b are electrically connected to the first external electrode 20a and second external electrode 20b alternately. As a result, the multilayer ceramic capacitor 100 is constituted as a stack of capacitor units. Also, the laminated body comprising the dielectric layers 11 and internal electrode layers 12 is such that internal electrode layers 12 are placed as the outermost layers in the lamination direction, and the outer side faces in the lamination direction of the laminated body, or specifically top face and bottom face in the examples of FIGS. 1 to 3, are covered with cover layers 13. The cover layers 13 have a ceramic material as the main component. For example, the cover layers 13 may be identical to, or different from, the dielectric layers 11 in terms of compositional makeup. It should be noted that the constitution is not limited to the one shown in FIGS. 1 to 3 so long as the first internal electrode layers 12a and second internal electrode layers 12b are exposed to different regions on the surface of the laminated body and electrically connected to different external electrodes. The “different regions on the surface of the laminated body” may be surface regions that are on opposing faces of the laminated body, respectively, or surface regions that are on adjoining faces of the laminated body, respectively, or surface regions that are different from each other on the same face of the laminated body. So long as they are separated from each other, the different external electrodes may extend onto other faces from the faces where the first internal electrode layers 12a and second internal electrode layers 12b are exposed to the surface regions of the laminated body, respectively.

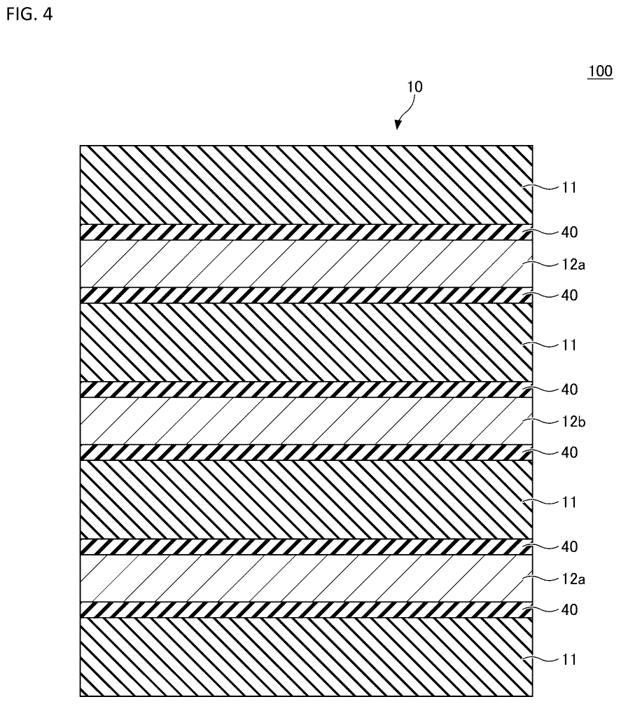

The element body 10 has multiple intermediate regions 40 (refer to FIG. 4) between the dielectric layers 11 and internal electrode layers 12, the details of which are described later. In FIGS. 1 to 3, the intermediate regions 40 are not shown.

The size of the multilayer ceramic capacitor 100 is not specifically limited, but it may be, for example, 0.25 mm in length, 0.125 mm in width, and 0.125 mm in height, or 0.4 mm in length, 0.2 mm in width, and 0.2 mm in height, or 0.6 mm in length, 0.3 mm in width, and 0.3 mm in height, or 1.0 mm in length, 0.5 mm in width, and 0.5 mm in height, or 3.2 mm in length, 1.6 mm in width, and 1.6 mm in height, or 4.5 mm in length, 3.2 mm in width, and 2.5 mm in height. It should be noted, however, that the sizes of the multilayer ceramic capacitor 100 listed above are only examples and the multilayer ceramic capacitor is not limited to the aforementioned sizes. The size of the multilayer ceramic capacitor 100 may be one, for example, that satisfies the relationship of “length>width≥height,” or “width>length≥height,” or “height>length≥width,” or “height>width≥length.” It should be noted that, for example, the length represents the size in the X-axis direction, width represents the size in the Y-axis direction, and height represents the size in the Z-axis direction.

As has been explained, the multilayer ceramic capacitor 100 in this embodiment has multiple dielectric layers 11 that are laminated along the Z-axis being the first axis, and multiple internal electrode layers 12 respectively placed along the first axis between the adjacent pairs of dielectric layers 11. In addition, the multilayer ceramic capacitor 100 in this embodiment has intermediate regions 40 placed between the dielectric layers 11 and internal electrode layers 12. The dielectric layers 11, internal electrode layers 12, and intermediate regions 40 are explained below.

### (2) Dielectric Layers

The dielectric layers 11 contain a compound expressed by the general formula ABO_{3-α} (0≤α≤1) and having a perovskite structure, as well as an additive element.

### (2-1) Components Contained in Dielectric Layers

### Compound Having Perovskite Structure

The compound having a perovskite structure, if of a stoichiometric composition, is expressed by the general formula ABO₃ because α representing an amount deviating from a stoichiometric composition is 0. The compound having a perovskite structure and expressed by the above general formula may be such that α is greater than 0 but no greater than 1. In other words, the compound having a perovskite structure and expressed by the above general formula may be more oxygen-deficient than a stoichiometric composition.

For the compound having a perovskite structure, one or more types selected from barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-Z}Zr_{z}O₃ (0≤x≤1, 0≤y≤1, 0≤z≤1) forming a perovskite structure, and the like, can be used.

Ba_{1-x-y}CaₓSr_{y}Ti_{1-Z}Zr_{z}O₃ encompasses barium strontium titanate, barium calcium titanate, barium zirconate, barium zirconate titanate, calcium zirconate titanate, barium calcium zirconate titanate, and the like. It should be noted that, no matter which material it is, the compound having a perovskite structure may contain oxygen deficiency.

Preferably the dielectric layers 11 contain barium titanate, for its superior dielectric properties, as the compound having a perovskite structure, or it may contain barium titanate as the main component, or it may be constituted only by barium titanate. Barium titanate has excellent dielectric properties supported by extremely high dielectric constant, small dielectric loss, and the like. Accordingly, the capacitance of the multilayer ceramic capacitor 100 can be increased when its dielectric layers 11 contain barium titanate as the compound having a perovskite structure. In this Specification, the “main component” refers to the component accounting for the highest percentage, by atomic percentage, of all components that are contained.

Also, in the dielectric layers 11, the compound having a perovskite structure may be contained as the main component. The dielectric layers 11 may contain the compound having a perovskite structure by 50% by mol or more, or 90% by mol or more, for example.

### Additive Element

The dielectric layers 11 can further contain an additive element. The additive element may be contained in a simple substance state, or as a compound formed with other elements, etc.

When the dielectric layers 11 contain an additive element, the service life of the multilayer ceramic capacitor 100 can be extended. In other words, the service life characteristics of the multilayer ceramic capacitor 100 can be enhanced when the dielectric layers 11 contain an additive element.

It has been confirmed that the greater the amount of the additive element added to the dielectric layers 11, the further the service life of the multilayer ceramic capacitor can be enhanced, and that the same trend applies when the dielectric layers 11 are made thinner. To prevent the additive element from concentrating locally in the dielectric layers 11, however, preferably its additive amount is selected according to the firing conditions, etc., during the manufacture of the multilayer ceramic capacitor, service life characteristics required, and the like.

The percentage of the additive element contained in the dielectric layers 11 is not specifically limited, and it can be added, and contained, according to the service life characteristics required of the multilayer ceramic capacitor and also to the extent that the intermediate regions described later will be formed.

The type of the additive element contained in the dielectric layers 11 is not specifically limited, but for the additive element, one or more types selected from holmium (Ho), yttrium (Y), samarium (Sm), dysprosium (Dy), europium (Eu), gadolinium (Gd), terbium (Tb), erbium (Er), thulium (Tm), ytterbium (Yb), and the like, can be used.

### Additives

The dielectric layers 11 can also contain additives as optional components.

The additives that can be contained by the dielectric layers 11 are not specifically limited, but examples include oxides containing one or more types of elements selected from zirconium (Zr), magnesium (Mg), manganese (Mn), molybdenum (Mo), vanadium (V), chromium (Cr), and rare earth elements (scandium (Sc), cerium (Ce), neodymium (Nd)), oxides containing one or more types of elements selected from cobalt (Co), nickel (Ni), lithium (Li), boron (B), sodium (Na), potassium (K), and silicon (Si), glasses containing one or more types of elements selected from cobalt, nickel, lithium, boron, sodium, potassium, and silicon, and the like.

### (2-2) Dielectric Layer Thickness

The dielectric layer 11 thickness is not specifically limited, but it is preferably 1.0 μm or less, or more preferably 0.8 μm or less, for example, from the viewpoint of making the multilayer ceramic capacitor 100 smaller while also increasing the number of layers to allow for increase in capacitance.

The lower-limit value of dielectric layer 11 thickness is not specifically limited, but it can be set to 0.2 μm or more, for example, from the viewpoint of increasing the productivity and yield.

The dielectric layer 11 thickness is evaluated in the cross-section that includes the first axis equaling the lamination direction. For example, preferably it is evaluated either in the cross-section that further includes the second axis set orthogonal to the lamination direction, or in the cross-section that further includes the third axis set orthogonal to the lamination direction and also orthogonal to the second axis, for the reason of ease of polishing and measurement. The multilayer ceramic capacitor 100 is polished in the third-axis direction in the case of the former, or in the second-axis direction in the case of the latter. The center part, as well as top edge part and bottom edge part, in the first-axis direction of the exposed dielectric layers 11 are selected for 10 layers each. Then, the thickness of the center part of each selected dielectric layer is measured, and the measured thickness is used as the thickness of each dielectric layer 11. Furthermore, the average value of the thicknesses of all selected and evaluated dielectric layers 11 can be used as the dielectric layer 11 thickness of the multilayer ceramic capacitor 100.

The examples shown in FIGS. 1 and 2, where the first axis representing the lamination direction corresponds to the Z-axis direction, are examples where the multilayer ceramic capacitor 100 has been polished along the Y-axis representing the third axis to expose the XZ-plane in which the dielectric layers 11 and internal electrode layers 12 are laminated.

In this case, 10 of the dielectric layers 11 positioned at the center along the Z-axis representing the first axis, and 10 each of the dielectric layers 11 positioned at the top edge and bottom edge along the Z-axis representing the first axis, are selected. In doing so, the dielectric layers 11 to be selected are chosen from inside a capacity part 14.

Then, each selected dielectric layer 11 is measured for thickness at the center along the X-axis representing the second axis, for use as the thickness of the dielectric layer 11. The same procedure is followed to measure the thickness for all selected dielectric layers 11, and the average value of the thicknesses of all measured dielectric layers 11 can be used as the dielectric layer 11 thickness of the evaluated multilayer ceramic capacitor 100.

It should be noted that the aforementioned dielectric layer 11 thickness, and the internal electrode layer 12 thickness described later, are measured from the observed cross-sectional images, etc., of the multilayer ceramic capacitor 100. The intermediate regions 40, which do not appear clearly, are to be measured based on the boundaries between the dielectric layers 11 and internal electrode layers 12 that can be visually confirmed when the aforementioned dielectric layer 11 thickness and internal electrode layer 12 thickness are measured. Accordingly, the aforementioned dielectric layer 11 thickness and internal electrode layer 12 thickness include the intermediate regions 40.

### (3) Internal Electrode Layers

### (3-1) Components Contained in Internal Electrode Layers

First, each part of the multilayer ceramic capacitor 100 relating to the internal electrode layers 12 is explained.

As illustrated in FIG. 2, the region where the first internal electrode layers 12a connected to the first external electrode 20a and second internal electrode layers 12b connected to the second external electrode 20b are facing one another represent a region of the multilayer ceramic capacitor 100 where electric capacity is generated. Accordingly, this region where electric capacity is generated is referred to as the “capacity part 14.” In other words, the capacity part 14 represents the region where each adjacent pair of the internal electrode layers connected to the different external electrodes are facing each other.

The region where the first internal electrode layers 12a connected to the first external electrode 20a are facing one another in the lamination direction without the second internal electrode layers 12b connected to the second external electrode 20b in between, is referred to as a first end margin 15a. Also, the region where the second internal electrode layers 12b connected to the second external electrode 20b are facing one another in the lamination direction without the first internal electrode layers 12a connected to the first external electrode 20a in between, is referred to as a second end margin 15b. Each end margin represents a region where the internal electrode layers connected to the same external electrode are facing one another in the lamination direction without the internal electrode layers connected to the different external electrode in between. The first end margin 15a and second end margin 15b are regions where electric capacity is not generated.

Side margins 16 represent regions provided on the outer side of the capacity part 14 along the third axis being orthogonal to the lamination direction and also orthogonal to the second axis, or in the direction along the Y-axis in the example of FIG. 3. In other words, the side margins 16 are regions adjoining, and on the outer side of, the capacity part 14 as viewed from the lamination direction, and regions adjoining, and on the outer side of, the capacity part 14 on the sides to which the internal electrode layers 12 are not extracted. The side margins 16, too, are regions where electric capacity is not generated.

Normally, the sintering temperature of the dielectric layer 11 material primarily containing a ceramic is higher than the sintering temperature of the internal electrode layer 12 material primarily containing a metal. Accordingly, the internal electrode layers 12 may be over-sintered if the laminated body, in which dielectric green sheets that will become dielectric layers 11 and metal conductive paste that will become internal electrode layers 12 are alternately placed in a manner achieving a prescribed shape, is fired at a temperature determined based on the sintering temperature of the dielectric layers 11. Over-sintering of the internal electrode layers 12 turns some or all of the internal electrode layers 12 into discontinuous spheroids, etc., thereby preventing the desired film shape from being achieved due to a lower continuity ratio, etc., and giving rise to problems such as lower capacitance.

Accordingly, a method of selecting appropriate firing conditions at the time of firing the laminated body so that over-sintering of the internal electrode layers 12 will not occur, is considered. However, doing so may prevent the one or more types of additive elements selected from holmium, yttrium, samarium, dysprosium, europium, gadolinium, terbium, erbium, thulium, ytterbium, and the like, and added to the dielectric layers 11 from fully diffusing in the dielectric layers 11 and causing them instead to concentrate locally inside the dielectric layers 11, leading to lower bias properties, etc. If, however, the amount of any additive element to be added to the dielectric layers 11 is reduced in order to keep the additive element from concentrating locally in the dielectric layers 11, the service life characteristics of the multilayer ceramic capacitor 100 may not be enhanced fully.

Accordingly, the inventor of the present invention conducted a study and confirmed that, when the internal electrode layers 12 contain copper, intermediate regions containing the additive element originating from the dielectric layers 11 and copper originating from the internal electrode layers 12, which did not generate under the conventional setup with copper-free internal electrode layers 12, would generate between the internal electrode layers 12 and dielectric layers 11. Also, according to the study conducted by the inventor of the present invention, the existence of such intermediate regions in the multilayer ceramic capacitor prevents the additive element from concentrating locally in the dielectric layers 11 even when the amount of the additive element in the dielectric layers 11 is increased and the laminated body is fired under conditions that will not cause over-sintering of the internal electrode layers 12, while at the same time allowing any excessive additive element to collect in the intermediate regions due to the effect of copper. As a result, the multilayer ceramic capacitor 100 can offer high service life characteristics as well as sufficient bias properties.

For this reason, the internal electrode layers 12 can contain a base metal element as the main component, as well as copper. The percentage of the copper contained in the internal electrode layers 12 is not specifically limited, and copper can be added thereto, and contained therein, to the extent that the aforementioned intermediate regions will be formed. Details of the intermediate regions are described later.

The internal electrode layers 12 can contain, in addition to copper, any components used in the internal electrode layers of multilayer ceramic capacitors. The internal electrode layers 12 may have as the main component, i.e., contain at the highest percentage by amount of substance, nickel (Ni), tin (Sn), or other base metal, or an alloy containing one or more types selected from the group of these base metals.

Due to its excellent electrical properties and ability to reduce cost, preferably nickel is contained in the internal electrode layers 12, or they can also contain nickel as the main component.

The main component in the first internal electrode layers 12a may be the same as, or different from, the main component in the second internal electrode layers 12b. As an example, the main components of the first internal electrode layers 12a and second internal electrode layers 12b may both be the same base metal, e.g., nickel.

### (3-2) Internal Electrode Layer Thickness

The internal electrode layer 12 thickness is not specifically limited, but it is preferably 0.8 μm or less, or more preferably 0.6 μm or less, for example, from the viewpoint of making the multilayer ceramic capacitor 100 smaller while also increasing the number of layers to allow for increase in capacitance.

The lower-limit value of internal electrode layer 12 thickness is not specifically limited, but it can be set to 0.4 μm or more, for example, from the viewpoint of increasing productivity and yield when the metal conductive paste being a slurry for internal electrode layers is formed into shape by means of printing using screen printing, gravure printing, or other printing method. If, for example, it is formed by means of sputtering, vapor deposition, or other thin-film process, the thickness can be set to 0.1 μm or more, which is less than when printing methods are used.

When evaluating the internal electrode layer 12 thickness, it is evaluated in a cross-section that includes the first axis equaling the lamination direction in the same manner the dielectric layer 11 thickness is evaluated. For example, preferably it is evaluated either in a cross-section that further includes the second axis set orthogonal to the lamination direction, or in a cross-section that further includes the third axis set orthogonal to the lamination direction and also orthogonal to the second axis, for the reason of ease of polishing and measurement.

The multilayer ceramic capacitor 100 is polished until the aforementioned cross-section becomes visible, and the center part, top edge part, and bottom edge part in the first-axis direction of the exposed internal electrode layers 12 are selected for 10 layers each. Then, the thickness of the center part of each selected internal electrode layer 12 is measured, and the measured thickness is used as the thickness of each internal electrode layer 12. Furthermore, the average value of the thicknesses of all selected and evaluated internal electrode layers 12 can be used as the internal electrode layer 12 thickness of the multilayer ceramic capacitor 100.

In the examples shown in FIGS. 1 and 2, the multilayer ceramic capacitor 100 is polished along the Y-axis to prepare a sample with an exposed XZ-plane in which the dielectric layers 11 and internal electrode layers 12 are laminated. Then, in the XZ-plane exposed by polishing, 10 internal electrode layers 12 positioned at the center along the Z-axis representing the first axis, and 10 internal electrode layers 12 each positioned at the top edge and bottom edge along the Z-axis representing the first axis, are selected. The internal electrode layers 12 to be selected are chosen from inside the capacity part 14.

Then, each selected internal electrode layer 12 is measured for thickness at the center along the X-axis representing the second axis, for use as the thickness of the internal electrode layer 12. The same procedure is followed to measure the thickness for all selected internal electrode layers 12, and the average value of the thicknesses of all measured internal electrode layers 12 can be used as the internal electrode layer 12 thickness of the evaluated multilayer ceramic capacitor 100.

### (4) Intermediate Regions

FIG. 4 shows a partially enlarged view of the dielectric layers 11 and internal electrode layers 12 in the element body 10. FIG. 4 provides an enlarged view of region C in FIG. 3, for example.

The multilayer ceramic capacitor 100 has intermediate regions 40 containing an additive element and copper, between the internal electrode layers 12 and dielectric layers 11. FIG. 4 is a schematically illustrated view and therefore the intermediate regions 40 are depicted as continuous layers having a constant thickness; however, they are not limited to such mode. The intermediate regions 40 may be discontinuous or their thickness may vary depending on the location, for example.

As shown in FIG. 4, the intermediate regions 40 can be placed in such a way that the surfaces of the internal electrode layers 12 are included as boundaries.

Presence or absence of the intermediate regions 40 can be confirmed by element mapping based on transmission electron microscope (TEM) or scanning transmission electron microscope (STEM) energy dispersive X-ray spectroscopy (EDX) analysis. As far as the evaluation is concerned, it is evaluated in the cross-section that includes the first axis equaling the lamination direction. For example, preferably it is evaluated either in the cross-section that further includes the second axis set orthogonal to the lamination direction, or in the cross-section that further includes the third axis set orthogonal to the lamination direction and also orthogonal to the second axis, for the reason of ease of polishing and measurement. The examples shown in FIGS. 1 and 2, where the first axis representing the lamination direction corresponds to the Z-axis direction, are examples where the multilayer ceramic capacitor 100 is polished along the Y-axis representing the third axis to expose the XZ-plane in which the dielectric layers 11 and internal electrode layers 12 are laminated. Then, by performing TEM/STEM-EDX analysis on a sample obtained by turning the aforementioned sample into a thin section of approx. 0.1 μm in thickness, presence or absence of the intermediate regions 40 can be confirmed.

For example, whether or not the intermediate regions 40 have been formed can be determined by observing, in the obtained element mapping results, the locations where the dielectric layers 11 and internal electrode layers 12 are laminated.

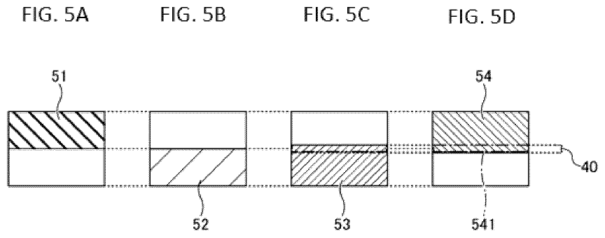

Performing TEM/STEM-EDX analysis on the above sample allows for confirmation of the distribution region of the element in the dielectric contained in the dielectric layers 11, as shown in FIG. 5A. FIG. 5A shows the distribution region of titanium 51 in an example where the dielectric layers 11 contain barium titanate as a.

Also, performing TEM/STEM-EDX analysis on the above sample allows for confirmation of the distribution region of the base metal element the internal electrode layers 12 contain as the main component, as shown in FIG. 5B. FIG. 5B shows the distribution region of nickel 52 in an example where the internal electrode layers 12 contain nickel as a base metal.

If an intermediate region 40 has been formed, the distribution region of copper 53 is present in a manner extending beyond the distribution region of nickel 52 being the distribution region of the base metal element contained in the internal electrode layers 12 as the main component, as shown in FIG. 5C. In this case, the distribution region of copper 53 is observed as extending as far as the distribution region of titanium 51 being the distribution region of the element in the dielectric contained in the dielectric layers 11.

Additionally, as shown in FIG. 5D representing the element mapping result of the additive element, the distribution region of additive element 54 is present in a manner extending beyond the distribution region of titanium 51 being the distribution region of the element in the dielectric contained in the dielectric layers 11. In this case, the distribution region of additive element 54 is observed as extending as far as the distribution region of nickel 52 being the distribution region of the base metal element contained in the internal electrode layers 12 as the main component.

In other words, when an element mapping performed on copper and the additive element shows an overlapping region between the distribution region of copper 53 and distribution region of additive element 54 near the boundaries where the dielectric layers 11 and internal electrode layers 12 are laminated, it can be determined that the intermediate regions 40 have been formed. As for the additive element, an uneven element distribution may be seen in the distribution region of additive element 54, and the concentration of the additive element may become higher in the region 541 corresponding to an intermediate region 40 shown in FIG. 5C, than in the dielectric layer 11 part.

It suffices that the intermediate regions 40 contain an additive element and copper, and the state of the additive element and that of copper in the intermediate regions 40 are not specifically limited. In the intermediate regions 40, the additive element and copper may be forming a compound, or the additive element and copper may each be forming a compound with other elements, etc. Also, in the intermediate regions 40, at least one of the additive element and copper may be present in an element state without forming a compound.

When the dielectric layers 11 contain an additive element, the service life characteristics of the multilayer ceramic capacitor 100 can be enhanced.

However, selecting the firing conditions in such a way as to avoid over-sintering of the internal electrode layers 12 has sometimes caused the bias properties to drop due to the additive element not diffusing fully but concentrating locally in the dielectric layers 11. Also, reducing the content of the additive element in the dielectric layers 11 in order to prevent the additive element from concentrating locally in the dielectric layers 11 has presented a concern that the service life characteristics of the multilayer ceramic capacitor 100 could not be enhanced fully.

In contrast, it is considered that adding copper to the internal electrode layers 12 causes the additive element, which has traditionally concentrated locally in the dielectric layers 11 after firing, to be trapped by copper and the intermediate regions 40 to be formed. Formation of the intermediate regions 40 prevents local concentration of the additive element without having to reduce the additive amount of the additive element in the dielectric layers 11. This means that, when the intermediate regions 40 are formed, drop in the bias properties can be prevented while enhancing the service life characteristics of the multilayer ceramic capacitor 100. As a result, the multilayer ceramic capacitor 100 can offer high service life characteristics as well as sufficient bias properties.

### Composition of Intermediate Regions

It suffices that the intermediate regions 40 contain an additive element and copper, and its compositional makeup is not specifically limited. From the viewpoint of increasing the service life characteristics and bias properties, in particular, of the internal electrode layers 12, preferably the average value of atomic ratio of the content of the additive element is 0.13% by atoms (hereinafter at %) or higher but no higher than 0.67 at %, and the average value of atomic ratio of the content of copper is 0.32 at % or higher but no higher than 3.15 at %, in the intermediate regions 40, based on three-dimensional atom probe analysis.

The average value of atomic ratio of the content of copper in the intermediate regions 40 based on three-dimensional atom probe analysis may be, for example, no lower than 0.5 times, but no higher than 3.0 times, the average value of atomic ratio of the content of copper in the center parts, along the Z-axis representing the first axis, of the adjoining internal electrode layers 12.

The average value of atomic ratio of the content of an element contained in the intermediate regions 40, if obtained using concentrations analyzed and quantified based on transmission electron microscope (TEM) or scanning transmission electron microscope (STEM) energy dispersive X-ray spectroscopy (EDX) analysis, may also include the average value of atomic ratio of the content of the element in parts, other than the intermediate regions 40, included in the sample, thereby lowering the accuracy of analysis. This is because, when producing a sample for TEM/STEM observation, obtaining a thin section of sample can lead to an inclusion of parts other than the intermediate regions 40 on the underside, etc., of the sample or otherwise render an accurate evaluation of the intermediate regions 40 no longer possible. For this reason, analyzing the content of an element contained in the intermediate regions 40 uses concentrations quantified based on three-dimensional atom probe (3DAP) analysis.

The average value of atomic ratio of the content of an additive element or copper in the intermediate regions 40 can be evaluated according to the procedure explained in “Examples” and is therefore not explained here.

The average value of atomic ratio of the content of copper in the center parts, along the Z-axis representing the first axis, of the internal electrode layers 12 adjoining the intermediate regions 40 can also be evaluated with a three-dimensional atom probe. In the multilayer ceramic capacitor 100, this can be evaluated at the center along the X-axis and Y-axis representing the second axis and third axis, respectively, corresponding to the center, along the Z-axis representing the first axis, of each internal electrode layer 12 to be evaluated.

### Method for Manufacturing Multilayer Ceramic Capacitor

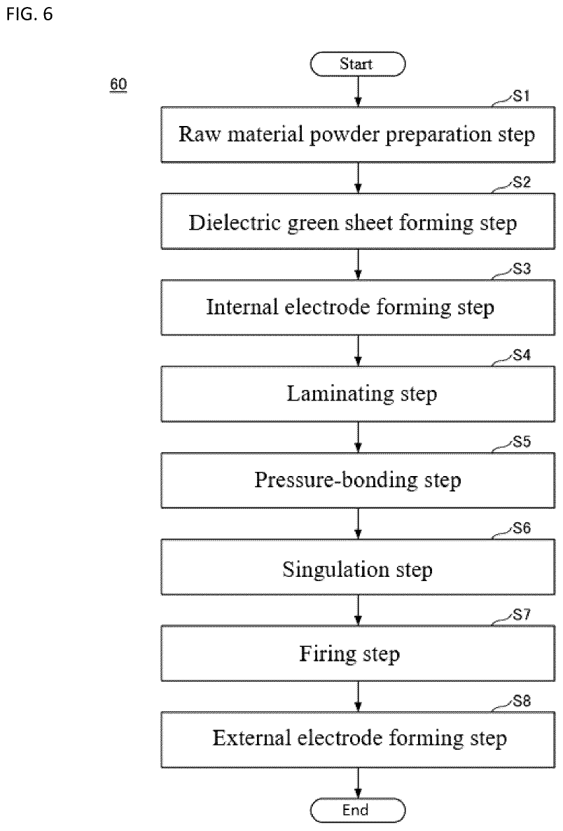

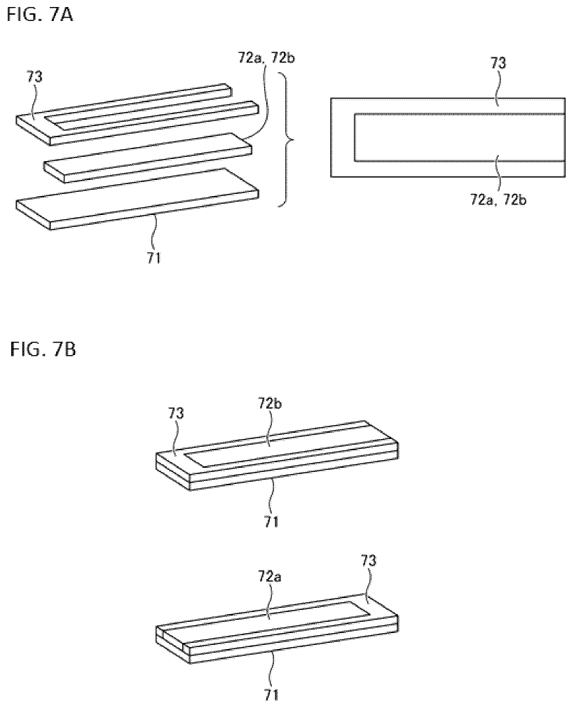

Next, how the multilayer ceramic capacitor 100 is manufactured is explained. FIG. 6 is a flow chart 60 illustrating a method for manufacturing the multilayer ceramic capacitor 100. FIGS. 7A and 7B provide drawings illustrating the method for manufacturing the multilayer ceramic capacitor 100.

The method for manufacturing the multilayer ceramic capacitor in this embodiment can comprise a dielectric green sheet forming step, an internal electrode layer forming step, and a firing step. The method for manufacturing the multilayer ceramic capacitor in this embodiment is explained below, together with optional steps other than the aforementioned steps.

### (1) Raw Material Powder Preparation Step (S1)

In the raw material powder preparation step, first a dielectric material for forming dielectric layers 11 is prepared. The A-site element and B-site element contained in the dielectric layers 11 are normally contained in the dielectric layers 11 in the form of a sintered compact of ABO_{3-α} (0≤α≤1) particles. For example, barium titanate is a tetragonal crystal compound having a perovskite structure and exhibits a high relative dielectric constant. Barium titanate can generally be obtained by reacting titanium dioxide or other titanium material with barium carbonate or other barium material. On how to synthesize the main component ceramic of the dielectric layers 11, various methods have been traditionally known, where the known examples include the solid phase method, sol-gel method, hydrothermal method, and the like. In this embodiment, any of the foregoing can be adopted.

In the raw material powder preparation step, the additive element as a simple substance, or a compound containing the additive element, can be added to the obtained ceramic material powder as an additive. Prescribed additive compounds can further be added to the obtained ceramic material powder according to the objectives. The additive compounds include oxides containing one or more types of elements selected from zirconium (Zr), magnesium (Mg), manganese (Mn), molybdenum (Mo), vanadium (V), chromium (Cr), and rare earth elements (scandium (Sc), cerium (Ce), neodymium (Nd)), oxides containing one or more types of elements selected from cobalt (Co), nickel (Ni), lithium (Li), boron (B), sodium (Na), potassium (K), and silicon (Si), glasses containing one or more types of elements selected from cobalt, nickel, lithium, boron, sodium, potassium, and silicon, and the like.

For example, a ceramic material can be prepared by wet-mixing an additive containing the additive element, as well as additive compounds, to the ceramic material powder and then drying and pulverizing the mixture. For example, the ceramic material obtained as described above may be put through a pulverizing process to adjust its grain size, or the grain size may be regulated by combining it with a classification treatment, if necessary. Following the above step, the material powder being the dielectric material is obtained.

### (2) Dielectric Green Sheet Forming Step (S2)

Next, in the dielectric green sheet forming step, a binder such as polyvinyl butyral (PVB) resin, an organic solvent such as ethanol or toluene, and a plasticizer, may be added to, and wet-mixed with, the obtained raw material powder. It should be noted that the binder, etc., may be added and wet-mixed together in the raw material powder preparation step (S1) when the ceramic material powder, etc., are mixed. Other necessary additives may also be added to the raw material powder, or to the slurry for forming dielectric green sheets.

In the dielectric green sheet forming step, dielectric green sheets 71 can be formed by coating the obtained slurry onto a substrate according to the die-coater method or doctor blade method, for example, and drying the slurry. The substrate is a polyethylene terephthalate (PET) film, for example. No drawing is provided that illustrates the dielectric green sheet forming step.

Accordingly, the dielectric green sheet forming step (S2) can form dielectric green sheets containing a compound expressed by the general formula ABO_{3-α} (0≤α≤1) and having a perovskite structure, as well as the additive element.

For the additive element, one or more types selected from holmium, yttrium, samarium, dysprosium, europium, gadolinium, terbium, erbium, thulium, and ytterbium can be contained, as has been explained.

### (3) Internal Electrode Layer Forming Step (S3)

As described above, the first internal electrode layers 12a and second internal electrode layers 12b can have nickel (Ni), tin (Sn), or other base metal element, or an alloy containing the foregoing, as the main component. The internal electrodes layers 12 contain copper in addition to the aforementioned main component.

The main component in the first internal electrode layers 12a may be the same as, or different from, the main component in the second internal electrode layers 12b. As an example, the main components of the first internal electrode layers 12a and second internal electrode layers 12b may both be the same nickel.

A metal conductive paste for forming a precursor to first internal electrode layers 12a and second internal electrode layers 12b can be prepared by kneading the main component selected from the above, copper, an organic binder, and a solvent. Copper may be added in a simple substance state, or it may be added in a compound state. Also, for the base metal element and copper, an alloy containing the base metal element being the main component, as well as copper, may be used, or the base metal element being the main component or a compound containing the base metal element may be added in a state of being surface-coated with copper or with a copper compound. It should be noted that, if necessary, the internal electrode paste can also contain the necessary amounts of various types of additive auxiliary agents such as dispersant.

In the internal electrode layer forming step, the metal conductive paste for forming internal electrode layers, which contains an organic binder, can be printed on the surface of the dielectric green sheets 71 by means of screen printing, gravure printing, or the like, as illustrated in FIG. 7A. This places first internal electrode layer patterns 72a for first internal electrode layers 12a or second internal electrode layer patterns 72b for second internal electrode layers 12b on the surface of the dielectric green sheets 71. Ceramic grains can also be added to the metal conductive paste as a common material. The main component of the ceramic grains is not specifically limited, but preferably it is the same as the main component ceramic of the dielectric layers 11. If ceramic grains are to be added as a common material, they can be added when kneading the metal conductive paste. The method for forming internal electrode layers is not limited to printing, and plating or vacuum vapor deposition, the sputtering method, or the CVD method, may be used.

Accordingly, the internal electrode layer forming step (S3) can produce ceramic green sheets by forming internal electrode layer patterns containing the base metal element being the main component, as well as copper, on the surface of the dielectric green sheets formed in the dielectric green sheet forming step.

Also, an ethyl cellulose-based or other binder and terpineol-based or other organic solvent can be added to the raw material powder being the dielectric material obtained in the raw material powder preparation step, with the mixture kneaded in a roll mill, to obtain a dielectric pattern paste for reverse pattern layers. Then, as illustrated in FIG. 7A, the dielectric pattern paste may be printed on the dielectric green sheets 71, in the peripheral areas where no internal electrode layer patterns are printed, thereby placing dielectric patterns 73 and filling the height gaps with the internal electrode layer patterns. The dielectric green sheets 71 on which the internal electrode layer patterns and dielectric patterns 73 have been printed are referred to as the “lamination units.”

### (4) Laminating Step (S4)

In the laminating step (S4), the lamination units can be laminated in such a way that the internal electrode layers alternate with the dielectric layers, and that the edges of the internal electrode layers are exposed alternately to the two end faces in the length direction of the dielectric layers and extracted alternately to the pair of external electrodes, as illustrated in FIG. 7B. To be specific, the dielectric green sheets 71 on which the first internal electrode layer patterns 72a and dielectric patterns 73 have been printed, and the dielectric green sheets 71 on which the second internal electrode layer patterns 72b and dielectric patterns 73 have been printed, are laminated in order. For example, there can be 100 to 500 layers of lamination units in terms of the number of layers.

### (5) Pressure-Bonding Step (S5)

In the pressure-bonding step, a prescribed number, such as 2 to 10 layers, of cover sheets can be laminated on top and bottom of the laminated body constituted by the lamination units that have been laminated, which are then thermocompression-bonded.

### (6) Singulation Step (S6)

In the singulation step, the pressure-bonded body that has been pressure-bonded can be singulated. For the singulation method, singulation using a dicer, laser cutting, or other existing method can be used as deemed appropriate.

### (7) Firing Step (S7)

In the firing step, the singulated laminated bodies, that is, laminated bodies constituted by the laminated ceramic green sheets, can be fired. The conditions for firing are not specifically limited, but preferably the temperature is raised at a rate of 30000° C./h or higher over a range from 600° C. to the firing temperature, with the firing temperature held for a period of 10 seconds or less.

By setting the rate of rise in temperature to 30000° C./h or higher and the holding period at the firing temperature to 10 seconds or less, over-sintering of the internal electrode layers 12 can be prevented.

The upper-limit value of rate of rise in temperature is not specifically limited, but preferably it is set to 50000° C./h or lower. The lower-limit value of holding period at the firing temperature is not specifically limited, either, but if a temperature rising zone and a temperature falling zone are disposed adjacent to each other in the firing furnace, then the firing temperature (maximum temperature) becomes unstable as these temperature zones interfere with each other, and therefore the holding period can be set preferably to 2 seconds or longer, or more preferably to 5 seconds or longer, for example, in order to avoid the above.

The firing temperature is not specifically limited, but preferably it is set to 1000° C. or higher but no higher than 1400° C. By firing at the above firing temperatures, diffusion of the additive element in the dielectric layers 11 can be fully promoted while also preventing over-sintering of the internal electrode layers 12.

The firing atmosphere in the firing step is not specifically limited, but it can be a reducing atmosphere with an oxygen partial pressure of 10⁻¹⁰ atm or higher but no higher than 10⁻⁸ atm.

### (8) External Electrode Forming Step (S8)

In the external electrode forming step, the first external electrode 20a and second external electrode 20b can be formed by a plating process, or the like. Following the above steps, the multilayer ceramic capacitor 100 is now complete.

The aforementioned steps are only an example, and the method for manufacturing the multilayer ceramic capacitor in this embodiment is not limited to the aforementioned mode.

### Other Embodiments

The foregoing described an embodiment in detail, but the present disclosure is not limited to a specific embodiment and various modifications and changes can be added within the scope described in “What Is Claimed Is.”

For example, while the aforementioned embodiment is applied to a multilayer ceramic capacitor having two terminal electrodes serving as external electrodes, the present disclosure can also be applied to a multilayer ceramic capacitor having three or more terminals.

Also, while the aforementioned embodiment is explained with respect to a multilayer ceramic capacitor as an example of multilayer ceramic electronic component, the present disclosure can be applied to multilayer ceramic electronic components in general. Such multilayer ceramic electronic components include, for example, chip varistors, chip thermistors, and the like.

### EXAMPLES

The present invention is explained below using specific examples; however, it is not limited to these examples.

### (1) Methods for Evaluation

### (1-1) Presence or Absence of Intermediate Regions

Presence or absence of the intermediate regions 40 was confirmed by element mapping based on transmission electron microscope (TEM) or scanning transmission electron microscope (STEM) energy dispersive X-ray spectroscopy (EDX) analysis. In the evaluation, as shown in FIGS. 1 and 2, the multilayer ceramic capacitor 100 was polished in a manner that polishing progresses along the Y-axis representing the third axis because the first axis representing the lamination direction corresponds to the Z-axis direction in FIGS. 1 and 2, and a sample with an exposed XZ-plane in which the dielectric layers 11 and internal electrode layers 12 were laminated was prepared. Then, by performing TEM/STEM-EDX analysis on a sample obtained by turning the aforementioned sample into a thin section of approx. 0.1 μm in thickness, presence or absence of the intermediate regions 40 was confirmed.

Specifically, in the obtained element mapping results, the locations where the dielectric layers 11 and internal electrode layers 12 were laminated were observed.

If an intermediate region 40 has been formed, the mapping result of copper shows that the distribution region of copper 53 is present in a manner extending beyond the distribution region of nickel 52 being the distribution region of the base metal element contained in the internal electrode layers 12 as the main component, as shown in FIG. 5C. In this case, the distribution region of copper 53 is observed as extending as far as the distribution region of titanium 51 being the distribution region of the element in the dielectric contained in the dielectric layers 11. Additionally, as shown in FIG. 5D, the mapping result of additive element shows that the distribution region of additive element 54 is present in a manner extending beyond the distribution region of titanium 51 being the distribution region of the element in the dielectric contained in the dielectric layers 11. In this case, the distribution region of additive element 54 is observed as extending as far as the distribution region of nickel 52 being the distribution region of the base metal element contained in the internal electrode layers 12 as the main component.

In other words, when an element mapping performed on copper and additive element showed an overlapping region between the distribution region of copper 53 and distribution region of additive element 54 near the boundary where the dielectric layer 11 and internal electrode layer 12 are laminated, it was determined that an intermediate region 40 had been formed.

By contrast, when at least one of the distribution region of copper 53 and distribution region of additive element 54 could not be confirmed, or when no overlapping region had been produced between the distribution region of copper 53 and distribution region of additive element 54, it was determined that no intermediate region 40 had been formed.

In the evaluation, the multilayer ceramic capacitor 100 was polished and, within the exposed XZ-plane, two internal electrode layers 12 positioned at the center along the Z-axis representing the first axis, and two internal electrode layers 12 each positioned at the top edge and bottom edge along the Z-axis representing the first axis, were selected. Then, the aforementioned observation was performed near the interface between each selected internal electrode layer 12 and a dielectric layer 11, over the entire periphery of the internal electrode layer 12. When selecting internal electrode layers 12 from the top edge, center, and bottom edge, respectively, along the Z-axis representing the first axis, the selections were made so that the first internal electrodes layers 12a and second internal electrode layers 12b would be equal in number. Also, the internal electrode layers 12 to be selected were chosen from inside the capacity part 14.

In Table 1, the “Intermediate Regions” column shows “Yes” when an intermediate region 40 was confirmed in any one of the evaluated locations, or “No” when no intermediate region was confirmed in any of the evaluated locations of the sample.

### (1-2) Average Value of Atomic Ratio of Content of Additive Element/Copper in Intermediate Regions

For the compositional analysis of the intermediate region 40, a three-dimensional atom probe (LEAP5000XS, manufactured by AMETEK, Inc.) was used to perform a compositional analysis, from the dielectric layer 11 to the internal electrode layer 12, along the Z-axis representing the first axis. The three-dimensional atom probe represents a method for measuring a three-dimensional atom distribution by applying high voltage to a sample and detecting, using a mass analysis device, those ions that have field-evaporated from the surface of the sample, and then successively detecting the individually detected ions in the depth direction and arranging the ions in the order detected.

In the measurement, the multilayer ceramic capacitor 100 was polished in a manner that polishing progresses along the Y-axis to prepare a sample with an exposed XZ-plane in which the dielectric layers 11 and internal electrode layers 12 were laminated, as shown in FIGS. 1 and 2, and the exposed XZ-plane was evaluated.

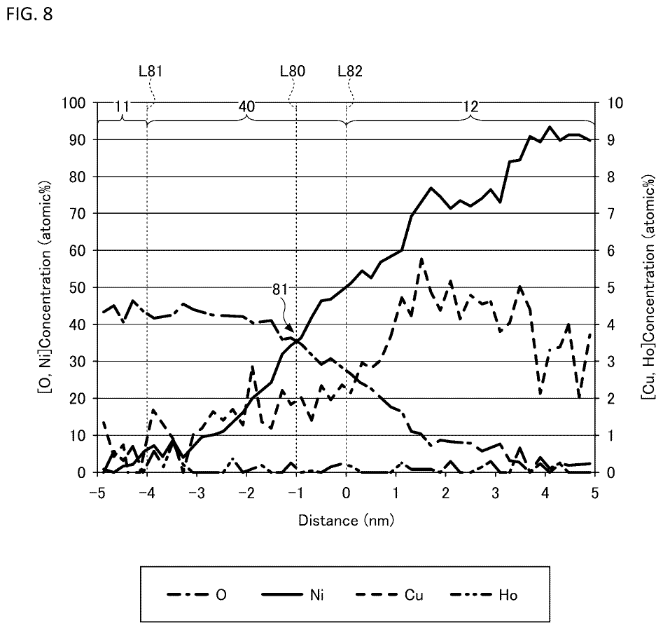

An example of measured results is shown in FIG. 8. As shown in FIG. 8, the content percentage of each of the elements contained in the dielectric layers 11 and internal electrode layers 12 can be measured and calculated by performing a three-dimensional atom probe analysis.

Of the measured results, the point of intersection 81 between the graph representing the content percentage of the oxygen due to the compound having a perovskite structure contained in the dielectric layers 11, and the graph representing the element due to the metal contained in the internal electrode layers 12 as the main component, can be used as a reference. In the graph shown in FIG. 8, the element due to the metal contained in the internal electrode layers 12 as the main component is nickel. Then, a straight line drawn inside the dielectric layer 11 region at a 3-nm distance away from a straight line L80 running through the point of intersection 81 is given as the straight line L81, while a straight line drawn at a 4-nm distance away from the straight line L81 in the dielectric layer 11 region is given as the straight line L82, and the region sandwiched between the straight line L81 and straight line L82 is specified as the intermediate region 40. In some embodiments, a thickness of the intermediate region is about 1 nm to about 10 nm (e.g., about 5 nm±about 1 nm), and in some embodiments, the intermediate region includes a point where atomic percentage of the base metal element and atomic percentage of the additive element intersect in the thickness direction.

It should be noted that, in Comparative Examples 1 to 9 where no intermediate regions were formed, evaluation was performed by specifying the intermediate region in the same manner.

Then, the average value of atomic ratio of the content of the additive element, and that of copper, in the intermediate regions 40 were obtained. In the evaluation, the multilayer ceramic capacitor 100 was polished and, within the exposed XZ-plane, one dielectric layer positioned at the center along the Z-axis representing the first axis, and one dielectric layer each positioned at the top edge and bottom edge along the Z-axis representing the first axis, were selected. Then, a three-dimensional atom probe analysis was performed from each selected dielectric layer 11 to the internal electrode layer 12 positioned above it along the first axis, to obtain the average value of atomic ratio of the content of holmium, and that of copper, relative to all elements detected in the intermediate regions 40. The dielectric layers 11 to be selected were chosen from inside the capacity part 14.

The average value of atomic ratio of the content of holmium, and that of copper, in all evaluated intermediate regions 40 are shown in the “Ho” and “Cu” columns under “Average value of atomic ratio of element content in intermediate regions.”

### (1-3) Highly Accelerated Service Life Test, Highly Accelerated Service Life Rating

From the samples in each Example, 100 units were selected, and a highly accelerated service life test (HALT) was performed on each of the selected samples. In the highly accelerated service life test, the 100 samples that had been manufactured under the same conditions were each impressed with a voltage of 6 V at 125° C. and the time to failure was measured.

The insulation resistance was measured every hour, and when the insulation resistance value dropped below 10 MΩ, the sample was determined to have failed.

The results are shown as normalized numerical values based on 100 representing the time to failure of the samples in Comparative Example 1.

When the result of highly accelerated service life was 100 or greater, an evaluation of “◯” was given as the highly accelerated service life rating. When the result of highly accelerated service life was 95 or greater but under 100, an evaluation of “Δ” was given as the highly accelerated service life rating. When the result of highly accelerated service life was under 95, an evaluation of “x” was given as the highly accelerated service life rating.

The evaluation of highly accelerated service life drops in the order of “◯,” “Δ,” and “x” of highly accelerated service life ratings, and the multilayer ceramic capacitor is considered to have high service life characteristics when its highly accelerated service life rating is “◯” or “Δ.”

### (1-4) DC Bias Properties, DC Bias Properties Rating

From the measured no-load capacity C0 and 3V DC-impressed capacity C3V, the rate of change in capacity was measured and calculated according to formula (1) below.

$$Rate of change in capacity = ( C 3 V - C 0 ) / C 0 \times 100 \qquad ( 1 )$$

In measuring the DC bias properties, 10 units of multilayer ceramic capacitors that had been manufactured under the same conditions in each Example were evaluated. Then, the average value of the DC bias properties of the 10 units of multilayer ceramic capacitors was used as the DC bias properties of the multilayer ceramic capacitors in the Example.

The “DC bias properties” column in Table 1 shows a standardized numerical value based on 100 representing the rate of change in capacity in Comparative Example 1.

When the result of DC bias properties was 100 or higher, an evaluation of “◯” was given as the DC bias properties rating. When the result of DC bias properties was 85 or higher but under 100, an evaluation of “Δ” was given as the DC bias properties rating. When the result of DC bias properties was under 85, an evaluation of “x” was given as the DC bias properties rating.

The evaluation of DC bias properties drops in the order of “◯,” “Δ,” and “x” of DC bias properties ratings, and the multilayer ceramic capacitor is considered to have sufficient bias properties when its DC bias properties rating is “◯” or “Δ.”

### (1-5) Overall Rating

For the overall rating, a “◯” was given when the highly accelerated service life rating was “◯” and DC bias properties rating was “◯,” and a “Δ” was given when either one or both of the highly accelerated service life rating and DC bias properties rating was/were “Δ” but neither was “x.” Also, for the overall rating, a “x” was given when at least one of the highly accelerated service life rating and DC bias properties rating was “x.”

### Example 1

Multilayer ceramic capacitors were manufactured according to the flow chart 60 described in FIG. 6.

To be specific, first a slurry was obtained by wet-mixing a barium titanium powder, a polyvinyl butyral (PVB) resin, a solvent, a plasticizer, a glass powder containing SiO₂ as a sintering auxiliary agent, and holmium oxide (Ho₂O₃) (raw material powder preparation step).

The obtained slurry was coated on substrate films and the slurry coated on the substrate films was dried, to obtain dielectric green sheets (dielectric green sheet forming step).

Next, an organic metal complex solution containing copper was added to, and mixed with, a powder of Ni being the main component metal element, to prepare a mixed powder. Ethyl cellulose (EC), polyvinyl butyral (PVB) resin, or the like, as a binder, as well as a solvent and a plasticizer, were added to, and wet-mixed with, the prepared mixed powder, to obtain a metal conductive paste for forming internal electrode layers. Then, by printing the metal conductive paste in some areas on the surface of the dielectric green sheets and thereby forming, on the respective dielectric green sheets, internal electrode layer patterns that contain nickel being a base metal element as the main component, as well as copper, ceramic green sheets that would become lamination units were formed (internal electrode layer forming step). These ceramic green sheets each comprise a dielectric green sheet and an internal electrode layer pattern formed on the surface of the dielectric green sheet.

Next, 500 lamination units were laminated to form a laminated body (laminating step).

Then, the laminated body was pressure-bonded and then singulated to obtain chip-shaped green laminated bodies (pressure-bonding step, singulation step).

Next, these chip-shaped green laminated bodies were put through a degreasing process in a 500° C. nitrogen atmosphere.

A metal conductive paste containing a metal filler whose main component is nickel, a common material, a binder, a solvent, and the like, was applied as a base layer on the green laminated bodies that had undergone the degreasing process, in a manner covering both end faces and continuing onto each side face, and dried. Thereafter, the green laminated bodies on which the base layer for external electrode had been applied, were put in a firing furnace and fired (firing step).

In the firing step, the temperature was raised from 600 to 1300° C. at the rate of rise in temperature shown in Table 1, and then held at the firing temperature of 1300° C. for 10 seconds. When the temperature was rising, the supply quantity of green laminated bodies and oxygen partial pressure were adjusted to prevent sudden changes in the firing atmosphere due to the gas generating from the green laminated bodies, and also to prevent cracks from generating in the fired products.

The fired laminated bodies were each put through a plating process to form a first external electrode 20a and a second external electrode 20b (external electrode forming step).

The obtained multilayer ceramic capacitors each had a chip shape of 1.0 mm×0.5 mm×0.5 mm, where the dielectric layer 11 thickness was 0.8 μm, internal electrode layer 12 thickness was 0.6 μm, and the number of layers was 500. The dielectric layer 11 thickness and internal electrode layer 12 thickness were evaluated according to the procedures already explained.

The obtained multilayer ceramic capacitors were evaluated as described above. The evaluation results are shown in Table 1.

### Examples 2 to 15

Multilayer ceramic capacitors were manufactured according to the same procedure in Example 1, except that the additive amounts of holmium and copper in the dielectric layer 11 and internal electrode layer 12 materials were changed to bring the holmium and copper contents in the intermediate regions in line with the values shown in Table 1. Also, the obtained multilayer ceramic capacitors were evaluated as described above. The evaluation results are shown in Table 1.

### Comparative Examples 1 to 8

Multilayer ceramic capacitors were manufactured according to the same procedure in Example 1, except that the additive amounts of holmium and copper in the dielectric layer 11 and internal electrode layer 12 materials were changed to bring the holmium and copper contents in the intermediate regions in line with the values shown in Table 1. Also, the obtained multilayer ceramic capacitors were evaluated as described above. The evaluation results are shown in Table 1.

### Comparative Example 9

Multilayer ceramic capacitors were manufactured according to the same procedure in Example 1, except that the rate of rise in temperature from 600 to 1300° C. in the firing step was changed to the rate of rise in temperature shown in Table 1.

When the cross-sections of the obtained multilayer ceramic capacitors were observed, it was confirmed that the internal electrode layers 12 had turned into discontinuous spheroids, etc., and did not have a film shape. In other words, the internal electrode layers 12 had been over-sintered. As a result, whether they had intermediate regions could not be evaluated accurately, which is indicated by “No” under “Intermediate regions.”

The obtained multilayer ceramic capacitors were evaluated as described above. The evaluation results are shown in Table 1.

TABLE 1

| | | | Average value of atomic | | | | | | |
|---|---|---|---|---|---|---|---|---|---|
| | | | ratio of element content | | | | | | |
| | Rate of | | in intermediate or | | Highly | Highly | | | |
| | rise in | | corresponding regions | | accelerated | accelerated | | DC bias | |
| | temperature | Intermediate | (at %) | | service life | service life | DC bias | properties | Overall |
| | (° C.) | regions | Ho | Cu | test | rating | properties | rating | rating |
| Example 1 | 30000° C./h | Yes | 0.13 | 0.32 | 105 | ∘ | 101 | ∘ | ∘ |
| Example 2 | | Yes | 0.13 | 0.63 | 201 | ∘ | 110 | ∘ | ∘ |
| Example 3 | | Yes | 0.13 | 1.89 | 232 | ∘ | 108 | ∘ | ∘ |
| Example 4 | | Yes | 0.27 | 0.63 | 251 | ∘ | 102 | ∘ | ∘ |
| Example 5 | | Yes | 0.27 | 1.89 | 291 | ∘ | 103 | ∘ | ∘ |
| Example 6 | | Yes | 0.53 | 1.89 | 302 | ∘ | 101 | ∘ | ∘ |
| Example 7 | | Yes | 0.53 | 3.15 | 348 | ∘ | 103 | ∘ | ∘ |
| Example 8 | | Yes | 0.67 | 3.15 | 401 | ∘ | 101 | ∘ | ∘ |
| Example 9 | | Yes | 0.13 | 3.15 | 305 | ∘ | 98 | Δ | Δ |
| Example 10 | | Yes | 0.67 | 0.32 | 322 | ∘ | 96 | Δ | Δ |
| Example 11 | | Yes | 0.67 | 4.41 | 390 | ∘ | 89 | Δ | Δ |
| Example 12 | | Yes | 0.67 | 0.16 | 217 | ∘ | 85 | Δ | Δ |
| Example 13 | | Yes | 0.04 | 1.89 | 95 | Δ | 99 | Δ | Δ |
| Example 14 | | Yes | 0.13 | 4.41 | 310 | ∘ | 86 | Δ | Δ |
| Example 15 | | Yes | 0.96 | 1.89 | 250 | ∘ | 88 | Δ | Δ |
| Comparative | | No | 0.13 | — | 100 | — | 100 | — | — |
| Example 1 | | | | | | | | | |
| Comparative | | No | 0.04 | — | 88 | x | 101 | ∘ | x |
| Example 2 | | | | | | | | | |
| Comparative | | No | 0.27 | — | 158 | ∘ | 84 | x | x |
| Example 3 | | | | | | | | | |
| Comparative | | No | 0.67 | — | 210 | ∘ | 82 | x | x |
| Example 4 | | | | | | | | | |
| Comparative | | No | 1.20 | — | 221 | ∘ | 80 | x | x |
| Example 5 | | | | | | | | | |
| Comparative | | No | — | 0.63 | 77 | x | 103 | ∘ | x |
| Example 6 | | | | | | | | | |
| Comparative | | No | — | 1.89 | 82 | x | 93 | Δ | x |
| Example 7 | | | | | | | | | |
| Comparative | | No | — | 3.15 | 90 | x | 89 | Δ | x |
| Example 8 | | | | | | | | | |
| Comparative | 10000° C./h | No | 0.13 | 1.89 | 91 | x | 99 | Δ | x |
| Example 9 | | | | | | | | | |

According to the results shown in Table 1, Examples 1 to 15 that resulted in formation of intermediate regions were given an overall rating of “O” or “A,” confirming that high service life characteristics and sufficient bias properties were achieved.

Modes of the present disclosure include the following, for example.

### <1>

A multilayer ceramic electronic component, comprising: multiple dielectric layers laminated along a first axis; multiple internal electrode layers respectively placed along the first axis between the adjacent pairs of the dielectric layers; and intermediate regions placed between the dielectric layers and the internal electrode layers; wherein, the dielectric layers contain a compound expressed by the general formula ABO_{3-α} (0≤α≤1) and having a perovskite structure, as well as an additive element; the internal electrode layers contain a base metal element as the main component, as well as copper; the intermediate regions contain the additive element as well as copper; and the additive element encompasses one or more types selected from holmium, yttrium, samarium, dysprosium, europium, gadolinium, terbium, erbium, thulium, and ytterbium.

### <2>

The multilayer ceramic electronic component according to <1>, wherein the average value of atomic ratio of the content of the additive element is 0.13 at % or higher but no higher than 0.67 at %, and the average value of atomic ratio of the content of copper is 0.32 at % or higher but no higher than 3.15 at %, in the intermediate regions, based on three-dimensional atom probe analysis.

### <3>

The multilayer ceramic electronic component according to <1> or <2>, wherein the internal electrode layers contain nickel.

### <4>

The multilayer ceramic electronic component according to any one of <1> to <3>, wherein the dielectric layers contain barium titanate as the compound having a perovskite structure.

### <5>

A method for manufacturing multilayer ceramic electronic component, comprising: a dielectric green sheet forming step to form dielectric green sheets that contain a compound expressed by the general formula ABO_{3-α} (0≤α≤1) and having a perovskite structure, as well as an additive element; an internal electrode layer forming step to form, on the surface of the dielectric green sheets, internal electrode layer patterns that contain a base metal element as the main component, as well as copper, and thereby produce ceramic green sheets; and a firing step to fire a laminated body constituted by the ceramic green sheets that have been laminated; wherein, the additive element encompasses one or more types selected from holmium, yttrium, samarium, dysprosium, europium, gadolinium, terbium, erbium, thulium, and ytterbium; and, in the firing step, the temperature is raised at a rate of rise in temperature of 30000° C./h or higher over a range from 600° C. to the firing temperature, and the holding period at the firing temperature is 10 seconds or less.

### <6>

The method for manufacturing multilayer ceramic electronic component according to <5>, wherein the firing temperature is 1000° C. or higher but no higher than 1400° C.

In this disclosure, in some embodiments, the material/composition constituting dielectric layers, internal electrode layers, intermediate regions, and perovskite structures may consist of required/explicitly indicated elements described in the present disclosure; however, “consisting of” does not exclude additional components that are known equivalents to the elements and/or unrelated components such as impurities ordinarily associated with the elements. Also, in some embodiments, the term “main component” refers to “primary, majority, or predominant component in terms of quantity or quality, and the term “mainly composed of” refers to “primarily, mostly, or predominantly composed of” in terms of quantity or quality. Further, in some embodiments which are silent as to known components used in this technology field, the known components can explicitly be excluded from the embodiments. Also, in some embodiments, any two numbers of a variable can constitute a workable range of the variable as the workable range can be determined based on routine work, and any ranges indicated may include or exclude the endpoints. Additionally, any values of variables indicated (regardless of whether or not they are indicated with “about”), such as the content of the additive element and the content of copper, may refer to precise values or approximate/rounded values and include equivalents, and may refer to average, median, representative, majority, etc. in some embodiments. In this disclosure, “a” may refer to a species or a genus including multiple species, while a plural may not exclude singular according to the context. Further, “the invention/disclosure” or “the present invention/disclosure” may refer collectively to at least one of the embodiments or examples explicitly or inherently disclosed herein. Also, in some embodiments, any one or more of the disclosed elements or components as options can be exclusively selected or can expressly be excluded, depending on the target piezoelectric ceramic to be manufactured, its target properties, etc., and/or for practical reasons, operational reasons, etc. Additionally, in the present invention/disclosure where conditions and/or structures are not specified, a skilled artisan in the art can readily provide such conditions and/or structures, in view of the present disclosure, as a matter of routine experimentation. etc.

### DESCRIPTION OF THE SYMBOLS

100 Multilayer ceramic capacitor
10 Element body
10a First side face
10b Second side face
11 Dielectric layer
12 Internal electrode layer
12a First internal electrode layer
12b Second internal electrode layer
13 Cover layer
14 Capacity part
15a First end margin
15b Second end margin
16 Side margin
20a First external electrode
20b Second external electrode
C Region
40 Intermediate region
51 Distribution region of titanium
52 Distribution region of nickel
53 Distribution region of copper
54 Distribution region of additive element
541 Region
60 Flow chart
S1 Raw material powder preparation step
S2 Dielectric green sheet forming step
S3 Internal electrode layer forming step
S4 Laminating step
S5 Pressure-bonding step
S6 Singulation step
S7 Firing step
S8 External electrode forming step
71 Dielectric green sheet
72a First internal electrode layer pattern
72b Second internal electrode layer pattern
73 Dielectric pattern
81 Point of intersection
L80 Straight line
L81 Straight line
L82 Straight line

What is claimed:

1. A multilayer ceramic electronic component, comprising:
multiple dielectric layers laminated along a first axis;
multiple internal electrode layers respectively placed along the first axis between adjacent pairs of the dielectric layers; and
intermediate regions placed between the dielectric layers and the internal electrode layers, respectively;
wherein:
the dielectric layers contain a compound expressed by a general formula ABO_{3-α} (0≤α≤1) and having a perovskite structure, as well as an additive element, wherein A and B represent an A-site element and a B-site element, respectively, of the perovskite structure;
the internal electrode layers contain a base metal element as a main component, as well as copper;
the intermediate regions have a higher content of the additive element than in the internal electrode layers, respectively, and a higher content of copper than in the dielectric layers, respectively, based on energy dispersive X-ray spectroscopy (EDX) analysis; and
the additive element encompasses one or more elements selected from holmium, yttrium, samarium, dysprosium, europium, gadolinium, terbium, erbium, thulium, and ytterbium.

2. The multilayer ceramic electronic component according to claim 1, wherein an average value of atomic ratio of a content of the additive element is 0.13 at % or higher but no higher than 0.67 at %, and an average value of atomic ratio of a content of copper is 0.32 at % or higher but no higher than 3.15 at %, in the intermediate regions, based on three-dimensional atom probe analysis.

3. The multilayer ceramic electronic component according to claim 1, wherein the internal electrode layers contain nickel.

4. The multilayer ceramic electronic component according to claim 2, wherein the internal electrode layers contain nickel.

5. The multilayer ceramic electronic component according to claim 1, wherein the dielectric layers contain barium titanate as the compound having the perovskite structure.

6. The multilayer ceramic electronic component according to claim 2, wherein the dielectric layers contain barium titanate as the compound having the perovskite structure.

7. A method for manufacturing multilayer ceramic electronic component, comprising:
a dielectric green sheet forming step to form dielectric green sheets that contain a compound expressed by a general formula ABO_{3-α} (0≤α≤1) and having a perovskite structure, as well as an additive element, wherein A and B represent an A-site element and a B-site element, respectively, of the perovskite structure;
an internal electrode layer forming step to form, on a surface of the dielectric green sheets, internal electrode layer patterns that contain a base metal element as a main component, as well as copper, and thereby produce ceramic green sheets; and
a firing step to fire a laminated body constituted by the ceramic green sheets that have been laminated;
wherein:
the additive element encompasses one or more elements selected from holmium, yttrium, samarium, dysprosium, europium, gadolinium, terbium, erbium, thulium, and ytterbium; and,
in the firing step, a temperature is raised at a rate of rise in temperature of 30,000° C./h or higher over a range from 600° C. to the firing temperature.

8. The method for manufacturing multilayer ceramic electronic component according to claim 7, wherein the firing temperature is 1,000° C. or higher but no higher than 1,400° C.

9. The method for manufacturing multilayer ceramic electronic component according to claim 7, wherein the holding period at the firing temperature is 10 seconds or less.
